(19) United States
(12) Patent Application Publication
(10) Pub. No.: US 2008/0083493 A1
(43) Pub. Date: Apr. 10, 2008

(54) Reusable mechanical fastener and vacuum seal combination

(76) Inventors: Michael D. Ridges, American Fork, UT (US); Joshua S. Dustin, Provo, UT (US); Trevor Boswell, Provo, UT (US); Courtney Robinson, Provo, UT (US)

Correspondence Address: THORPE NORTH & WESTERN, LLP., P.O. Box 1219, SANDY, UT, 84091-1219, US

(21) Appl. No.: 11/546,017

(22) Filed: Oct. 10, 2006

(51) Int. Cl. B32B 37/00; B29C 65/00

(52) U.S. Cl. 156/285; 156/382

(57) ABSTRACT

A vacuum sealing system comprising a first member having a surface defining, at least in part, an operating area; a flexible cover, having a sealing surface, configured to envelop the operating area of the first member; means for applying negative pressure to the operating area; a sealing component located between the surface of the first member and the sealing surface of the cover; and a reusable mechanical fastener operable to mechanically couple the cover to the first member with sufficient force so as to compress the sealing component, and to seal the operating area to permit drawing of a negative pressure.

### FIELD OF THE INVENTION

This invention relates generally to the manufacture of products, such as composite materials, in which a negative pressure environment is created for one or more purposes. More particularly, the present invention relates to the sealing mechanism or sealing means used to seal a flexible cover or material to another member to create an airtight seal, and to permit the formation of a negative pressure environment. In one specific application, the present invention relates to the sealing mechanism or sealing means used to seal a vacuum bag or cover to a mold over a composite fiber lay-up for the manufacture of a composite material.

### BACKGROUND OF THE INVENTION AND RELATED ART

Composite materials play an important role in industrial and commercial product applications. This is largely attributable to their unique properties and characteristics as compared with other materials. Amongst other characteristics, composite materials are lightweight, high in strength and stiffness, chemical and corrosion resistance, and have tailorable electrical and thermal properties.

Generally speaking, fiber reinforced resin composite materials are fabricated using one of two basic techniques. In a “dry” lay-up process, fiber forms that have been pre-wetted with resin, forming a “pre-preg” structure, are laid up against a mold to provide the proper shape. The process is “dry” because no new resin is introduced to the fiber forms after the material has been laid up against the mold. In a “wet” lay-up process, a dry fiber reinforcement material, otherwise known as a preform, is laid up on a mold and sprayed, brushed, or otherwise coated or “wetted” with the resin. If the resin employed is of the thermoset type, the piece may then cured at an elevated temperature in an autoclave to form the fiber reinforced plastic structure. In other techniques the resin may be designed to polymerize at ambient temperature.

Composite manufacturing methods can be further distinguished by their use of either closed mold or open mold processes. A common manufacturing method using a closed mold process is the resin transfer molding process (hereinafter “RTM”). RTM is a version of the “wet” lay-up process in which a continuous strand mat or fiber preform is positioned on an open female mold or tool. A rigid, cooperatively shaped male mold is mated to the female mold and the sealing edges of the two are pressed together, creating a cavity of fixed dimensions which encloses the fiber preform. A catalyzed resin mix is thereafter pumped into the cavity formed between the two mold surfaces. After a suitable curing cycle, the part is removed from the mold.

Another common method for the manufacture of composite materials is vacuum assisted resin transfer molding (hereinafter “VARTM”), more commonly referred to as an “infusion” process. This process involves using open molds and a “wet” lay-up process, wherein a mat of dry fiber reinforcement material is positioned in a single open mold cavity. The fiber reinforcement lay-up and the open mold is then enclosed within an impermeable liner or vacuum bag. The dry fiber mat, or ‘preform’, is applied over a mold surface to form a lay-up of fiber reinforcement material of desired thickness. Resin injection ports and vacuum suction ports are installed at selected locations around the preform lay-up, and a flexible, gas impervious vacuum sheet, liner, membrane, film, or bag (hereinafter “bag” or “vacuum bag”) is placed over the entire assembly.

The edges of the bag are clamped or sealed around the periphery of the mold to form a sealed vacuum envelope surrounding the preform lay-up. A vacuum source is placed in pneumatic or fluid communication with the space between the open mold and the bag and is used to draw a vacuum and to create a negative pressure within the sealed vacuum envelope. Resin is then introduced, or ‘infused’, into the interior of the vacuum bag after negative pressure is applied. Under ideal circumstances, the induced negative pressure serves to shape the article to the mold, to draw the resin through the fiber mat, completely “wet” the fiber, and to remove any air that might cause the formation of voids within the completed article. The negative pressure is maintained while the wetted fiber is pressed and cured against the mold to form the fiber reinforced composite structure or part having the desired shape. Once the composite part is fully cured, the bag is normally removed from the molded article and discarded as waste.

In order to seal a portion, namely the periphery, of the vacuum bag to the mold in a conventional vacuum bagging or VARTM process, a sealant of some kind must be used. In most cases, the sealant comprises a sealant tape that is essentially an adhesive strip used to bond the bag to the mold surface. The sealant tape can comprise a double sided adhesive, wherein a paper backing may be used to permit easy installation of the sealant tape to the mold. Once in place, the paper backing may be removed and the vacuum bag applied thereto.

Sealant tape, which is sometimes referred to as tacky tape, has many drawbacks. First, the method of properly installing traditional vacuum bags is labor-intensive and time consuming, especially for very large structures, such as boat hulls. This is mostly due to the manual steps required to properly seal the vacuum bag to the mold. Indeed, trained technicians must accurately lay the vacuum bag over the contoured surface of the open mold and fiber preform. Attention must be taken when taping and sealing the outer edges of the bag against the sealing surfaces around the periphery of the open mold. Special care is required when installing the resin injection and vacuum suction ports to properly tape and seal the holes in the bag. Furthermore, additional up-front effort must also be spent assembling resin supply and vacuum suction manifolds which connect to the injection and vacuum ports.

Second, with respect to one-time use vacuum bags, the sealant or tacky tape is not reusable. Typically, each time a composite material is fabricated and the vacuum bag peeled away, the sealant tape is rendered virtually unusable. As such, the sealant tape is typically discarded along with the vacuum bag. This creates unnecessary expense and contributes to the extended times it takes to fabricate subsequent composite materials.

Third, with respect to reusable vacuum bags, which are more robust than their one-time use counterparts, sealant or tacky tape does not provide enough structural support to properly secure the reusable vacuum bag to the mold during the manufacturing process. This can negatively affect the seal and the integrity of the negative pressure environment upon application of the negative pressure or vacuum, which can ultimately undermine the quality and integrity of the composite material being formed.

Although not specifically mentioned, other problems with conventional sealant tape will be obvious to those skilled in the art.

FIG. 1 illustrates a partial cross sectional view of a prior art vacuum bagging system 10 comprising a forming tool or mold 14 having a composite lay-up 22 situated about a surface 18 of the forming tool or mold 14. The lay-up 22 may comprise any suitable material used in forming composite parts. In addition, lay-up 22 may include a first release layer 26, an uncured or partially cured prepreg member 30, a second release layer 34, and a breather or breather/bleeder layer 38. Vacuum port 42 is generally in direct contact with or in communication with the breather/bleeder layer 38, and can communicate with the breather/bleeder layer through the vacuum bag 52. Vacuum port 42 defines an opening 46 and can be coupled to the vacuum bag 52. Sealant tape, such as heat sealant tape 70 and/or chromate sealant tape 74, is used to seal the vacuum bag 52 to the forming tool 14.

### SUMMARY OF THE INVENTION

In light of the problems and deficiencies inherent in the prior art, the present invention seeks to overcome these by providing a sealing mechanism that utilizes a reusable mechanical fastener to secure a cover, such as a vacuum bag, to the surface of a first member, such as a mold, wherein the reusable mechanical seal is operable with a resilient sealing member or component to create an airtight seal between the cover and the first member.

In accordance with the invention as embodied and broadly described herein, the present invention features a vacuum sealing system comprising a first member having a surface defining, at least in part, an operating area; a flexible cover, having a sealing surface, configured to envelop the operating area of the first member; means for applying negative pressure to the operating area; a sealing component located between the surface of the first member and the sealing surface of the cover; and a reusable mechanical fastener operable to mechanically couple the cover to the first member with sufficient force so as to compress the sealing component, and to seal the operating area to permit drawing of a negative pressure.

The present invention also features a vacuum sealing system comprising a first member having a surface; a flexible, reusable cover having a sealing surface configured to interface with the surface of the first member; a reusable mechanical fastener operable with each of the cover and the first member, the reusable mechanical fastener being configured to temporarily couple together to secure the cover to the first member; and a resilient sealing component positioned on a surface of one of the cover and the first member, the sealing component temporarily sealing the cover to the first member upon coupling of the mechanical fastener to enable an airtight seal, and to permit formation of a negative pressure environment between the cover and the first member.

The present invention further features a vacuum sealing system comprising a first member having a surface; a flexible, reusable cover having a surface configured to interface with the surface of the first member; a receiving component located on one of the first member and the cover; a fastening component located on one of the first member and the cover other than that the receiving component is located, the fastening component mechanically releasably engaging the receiving component to temporarily couple together to secure the cover to the first member; and a resilient sealing component operable with the fastening and receiving components, and positioned on a surface of one of the first member and the cover, the sealing component temporarily sealing the surfaces of the first member and the cover, upon coupling the fastening component to the receiving component, to enable an airtight seal, and to permit formation of a negative pressure environment between the cover and the first member.

The present invention still further features a reusable vacuum bag comprising a flexible material having a sealing surface and an opposing surface; one of a receiving component and a fastening component of a reusable mechanical fastener operable with and disposed about the sealing surface, the receiving component functioning to mechanically interact with the fastening component to form a mechanical coupling capable of temporarily securing the vacuum bag to a mold, the mold comprising the other of the receiving and fastening components not disposed about the vacuum bag, the reusable mechanical fastener operable with a resilient sealing component positioned between and supported by one of the vacuum bag and the mold to enable an airtight seal, and to permit formation of a negative pressure environment between the vacuum bag and the mold.

The present invention still further features a method for temporarily sealing a cover to a first member to permit formation of a negative pressure environment between these, the method comprising obtaining a first member having a surface; obtaining a reusable cover having a sealing surface, the first member and the cover operable with a reusable mechanical fastener and a resilient sealing component to mechanically couple the cover to the first member with sufficient force so as to compress the sealing component, and to permit drawing of a negative pressure, the reusable mechanical fastener comprising a fastening component and a receiving component; and coupling the fastening component to the receiving component to secure together the first member and the cover, and to cause the resilient sealing component to seal against the surfaces of the first member and the cover to enable an airtight seal.

The present invention still further features a method for temporarily sealing a cover to a first member to permit formation of a negative pressure environment, the method comprising obtaining a first member, the first member operable with a cover to facilitate formation of a vacuum enclosure; positioning a receiving component of a reusable mechanical fastener on a surface of one of the first member and the cover; positioning a fastening component of the reusable mechanical fastener on a surface of the other of the first member and the cover, the receiving component operable with the fastening component to mechanically couple together, and to secure the cover to the first member; positioning a resilient sealing component about the surface of one of the first member and the cover; and coupling the fastening component to the receiving component to secure the cover to the first members, and to cause the resilient sealing component to deform and seal against the surfaces of the first member and the cover to enable an airtight seal.

The present invention still further features a method for facilitating formation of a negative pressure environment between a cover and a first member, the method comprising providing a reusable mechanical fastener operable to temporarily secure a reusable cover to a first member, the reusable mechanical fastener comprising: a receiving component configured to be located on a surface of one of the cover and the first member; a fastening component configured to be located on a surface of the other of the cover and the first member; facilitating respective application of the receiving and fastening components of the reusable mechanical fastener to either of the cover and the first member; providing a resilient sealing component operable with the reusable mechanical fastener; facilitating the positioning of the resilient sealing component between the surfaces of the cover and the first member; and facilitating the coupling of the receiving and fastening components of the reusable mechanical fastener to secure the cover to the first member, and to cause the resilient sealing component to deform and seal against the surfaces of the cover and the first member to enable an airtight seal, and to permit formation of a negative pressure environment.

The present invention still further features a method for sealing the surface of a vacuum bag for use in the manufacture of composite parts, the method comprising obtaining a reusable vacuum bag having a sealing surface; obtaining a mold having a surface, coupling the vacuum bag to the mold via a reusable mechanical fastener operable with the surfaces of the vacuum bag and the mold, the coupling causing a resilient sealing component located between the surfaces to deform and seal the surfaces together to enable an airtight seal, and to enable formation of a negative pressure environment between the vacuum bag and the mold.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a partial, cross-sectional side view of a conventional vacuum bagging system in accordance with the prior art;

FIG. 2 illustrates a general block diagram depicting the various components of a vacuum sealing system in accordance with the present invention;

FIG. 3 illustrates a partial perspective view of a vacuum sealing system having a reusable mechanical fastener operable with a sealing component in accordance with one embodiment of the present invention;

FIG. 4-A illustrates a partial, cross-sectional side view of a vacuum sealing system in accordance with one exemplary embodiment, wherein either the receiving component or the fastening component of the mechanical fastener, and the sealing component are each supported about the mold;

FIG. 4-B illustrates the vacuum sealing system of FIG. 4-A in use, wherein the reusable fastener is fastened, thus securing the cover or vacuum bag and the mold together, and the sealing component is compressed and deformed to seal against the surfaces of the vacuum bag and the mold, thus sealing the operating area;

FIG. 5 illustrates a partial, cross-sectional side view of a vacuum sealing system in accordance with one exemplary embodiment, wherein either the receiving component or the fastening component of the mechanical fastener, and the sealing component are each supported about a sealing surface of the cover or vacuum bag;

FIG. 6 illustrates a partial side view of a vacuum sealing system, wherein the reusable mechanical fastener comprises a plurality of snap-type fasteners (only one of which is shown) in accordance with one exemplary embodiment of the present invention;

FIG. 7 illustrates a partial side view of a vacuum sealing system, wherein the reusable mechanical fastener comprises a continuous hook and loop type fastener (or a plurality of the same) in accordance with one exemplary embodiment of the present invention; and

FIG. 8 illustrates a partial side view of a vacuum sealing system, wherein the reusable mechanical fastener comprises a continuous tongue and groove type fastener in accordance with one exemplary embodiment of the present invention.

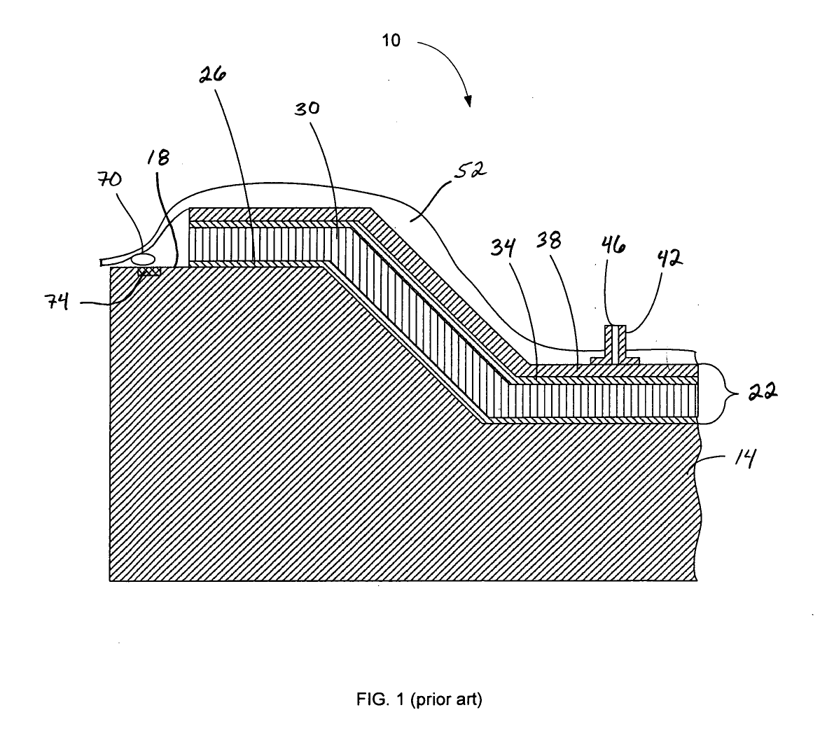

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and system for sealing a cover to a first member for the purpose of sealing am operating area, wherein the cover is intended to envelop, at least in part, the first member. The system comprises a reusable mechanical fastener operable with a resilient sealing component. More specifically, the present invention features a vacuum sealing system comprising a reusable mechanical fastener, such as a hook and loop-type fastener, a snap-type fastener, a zipper-type fastener, a magnetic-type fastener, or a tongue and groove-type fastener, in combination with a resilient airtight sealing component for applications where one member, namely a cover, is intended to be temporarily sealed to another member to form or create an airtight seal, such as in the case of reusable vacuum bags being temporarily sealed to a mold for the manufacture of composite parts. The present invention describes placing the reusable mechanical fastener and the sealing component on the surface of one or both of the members to be sealed. The mechanical fastener holds the first and second members in place with respect to one another to enable an enhanced airtight seal therebetween.

The present invention provides several significant advantages over prior related methods and systems for sealing a cover to a first member, some of which are recited throughout the following more detailed description. These advantages, and others, will be apparent to those skilled in the art in light of the detailed description set forth below, with reference to the accompanying drawings. Any recognized advantages are not meant to be limiting in any way. Indeed, one skilled in the art will appreciate that other advantages may be realized, other than those specifically recited herein, upon practicing the present invention.

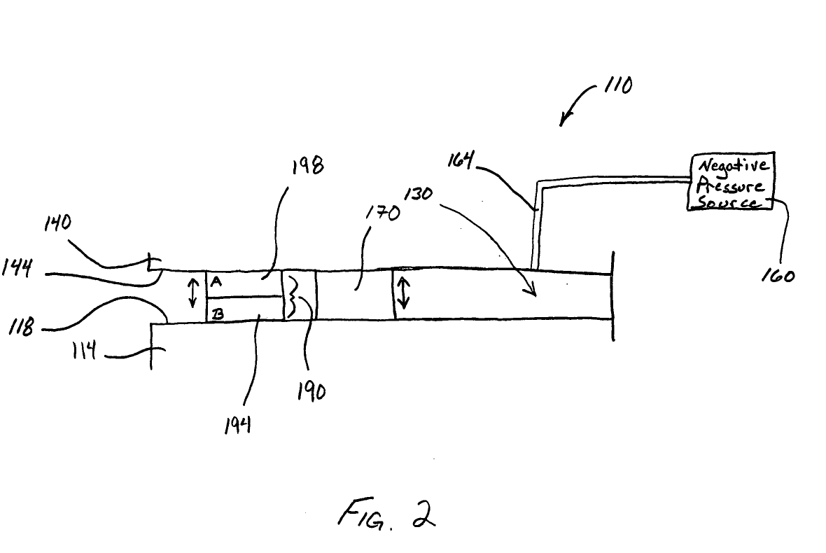

With reference to FIG. 2, illustrated is a general block diagram of a vacuum sealing system in accordance with one exemplary embodiment of the present invention. As shown, the vacuum sealing system 110 comprises a first member 114 having a surface 118 configured to define, at least in part, a lower boundary of an operating area 130. The operating area 130 is intended to be contained, at least in part, within a negative pressure environment, which environment may be induced by activating a negative pressure source 160 in fluid communication, via fluid line 164, with the operating area 130.

The first member 114 is configured to interface with a sealing surface 144 of a cover 140, which cover 140 is designed to be flexible or bendable, and to envelop or cover, at least in part, the surface 118 of the first number 114, as well as to define an upper boundary of the operating area 130. The first member 114 further operates with the cover 140 to define the boundaries of the negative pressure environment. In other words, a negative pressure environment is created by laying the cover 140 over the first member 114, and drawing a vacuum between the sealing surface 144 of the cover 140 and the surface 118 of the first member 114.

In order to provide an adequate negative pressure environment, and to maintain the integrity of such an environment, the cover 140 is intended to be secured to the first member 114, and to be sealed thereto using a resilient sealing component 170. The resilient sealing component 170 is specifically designed and intended to seal against the surfaces of the cover 140 and the first member 114, and to define the perimeter or periphery of the negative pressure environment. In other words, the sealing component 170 may be configured to define an area of negative pressure.

The resilient sealing component 170 may comprise any number of different types, but preferably comprises a type capable of deforming under a load to some degree so as to increase the amount of surface area between the cover 140 and the first member 114 that is actually in contact with the sealing component 170 and being sealed. This helps to enhance the integrity of the seal, and to reduce the chance of seal failure. For example, as the negative pressure in the system is induced, and as air is displaced out of the interface between the cover 140 and the first member 114, the cover is caused to exert a positive downward pressure against the first member 114. This positive pressure functions to deform the sealing component 170, thus sealing the cover 140 to the first member 114. The negative pressure may increased, thus continuing to cause the seal to deform, until the seal has reached its maximum deformation. At this point, the surface area about the cover 140 and the first member 114 being sealed is maximized.

The resilient sealing component 170 may comprise many different types and configurations. Preferably, the sealing component comprises an elongate configuration, and at least a degree of resiliency so as to enable the sealing component 170 to deform and conform, at least in part, to the surface(s) it is sealing. In one exemplary embodiment, the sealing component 170 comprises an elongate, silicone “D” or “P” seal having a circular cross-section and a flange extending therefrom. However, other types of sealing components, and sealing components of various other material makeup, are contemplated herein and will be obvious to those skilled in the art. For example, a variety of extruded seal products may be used. The sealing component may comprise a material makeup selected from any number of different materials, such as silicone, vinyl, EPDM, latex, a thermoplastic elastomer, an elastomeric gel, and others known in the art. As such, those discussed herein and/or shown in the drawings are not intended to be limiting in any way.

To secure the reusable cover 140 to the first member 114, the present invention vacuum sealing system 110 further comprises a reusable mechanical fastener 190. The reusable mechanical fastener 190 operates to mechanically couple or fasten together to secure the cover 140 in a desired position with respect to the first member 114. As shown, the reusable mechanical fastener 190 comprises a receiving component 194 (A) and a fastening component 198 (B). The receiving component 194 may be located on or secured to either one of the first member 114 and the cover 140. Likewise, the fastening component 198 may be located on or secured to either one of the first member 114 and the cover 140. The receiving component 194 is designed to releasably and repeatedly receive and mechanically couple the fastening component 198. It is further noted that multiple reusable mechanical fasteners and sealing components may be used, with the components thereof secured to or located on one or both of the cover and the first member.

The reusable mechanical fastener 190 is preferably configured to facilitate the creation of a seal between the first member 114 and the cover 140. More specifically, the reusable mechanical fastener 190 is preferably configured such that actuation or coupling thereof requires a sufficient amount of force so as to at least partially deform and compress the sealing component 170, or at least to bring the surface 118 of the first member 114 in contact with at least a portion of the sealing component 170, and/or the surface 144 of the cover 140 in contact with at least a portion of the sealing component 170. The sealing component 170 may be further compressed, and the resulting seal enhanced, as the negative pressure environment is induced and the negative pressure increased. As such, the sealing component 170 functions to seal the cover 140 and the first member 118 to permit the drawing of a negative pressure or vacuum between the cover and the first member 114, and particularly within the operating area 130.

As will be discussed below, the reusable mechanical fastener 190 may comprise many different types and configurations, each of which are designed to releasably couple together to enable the cover 140 and the first member 114 to be temporarily secured together. In addition, the sealing component 170 is intended to temporarily seal the cover 140 and the first member 114, thus creating a temporary seal that is maintained until the reusable mechanical fastener 190 is decoupled or detached, and the cover 140 is removed from the first member 114.

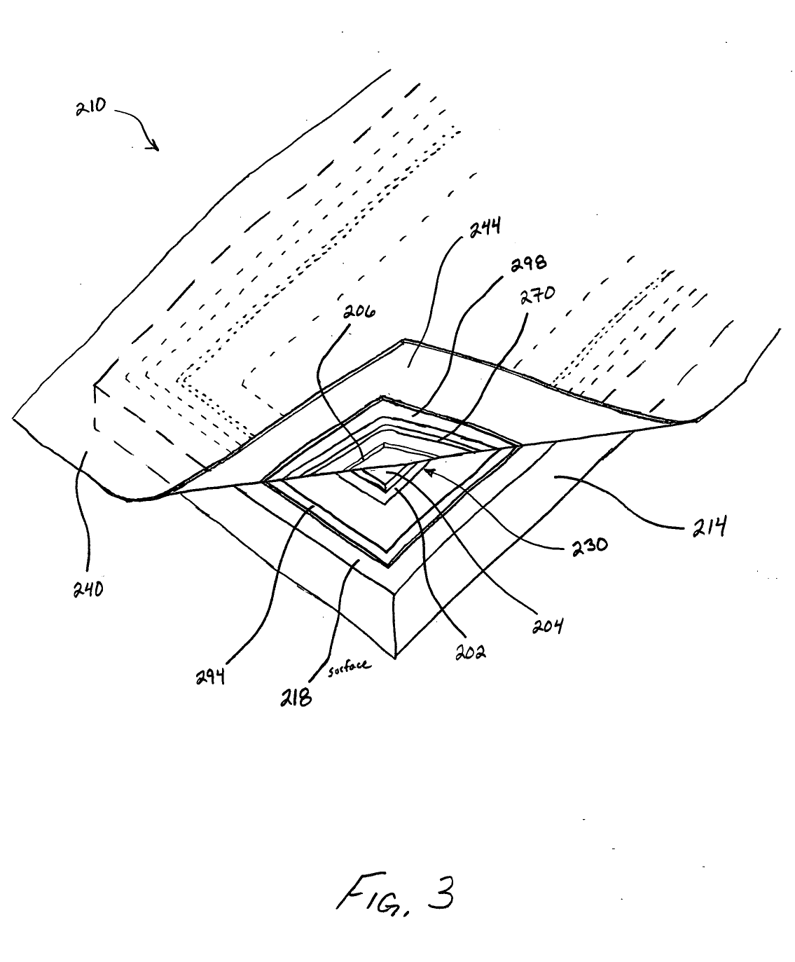

With reference to FIG. 3, illustrated is a perspective view of one exemplary type of vacuum sealing system, namely a vacuum bagging system for use in the manufacture of composite parts. It is noted that the following disclosure describes various aspects of a particular type of vacuum sealing system, many of which aspects are also applicable to other types of vacuum sealing systems. As such, the discussion on vacuum bagging-type sealing systems may include subject matter applicable to one or more other types of vacuum sealing systems, and it is intended that this subject matter be incorporated therein as would be recognized by one skilled in the art.

As shown, the vacuum system 210 comprises a first member in the form of an open mold 214 configured to provide the tooling support for a composite lay-up. The open mold 214 may comprise any size and configuration, and may be formed in accordance with known practices. The open mold 214 comprises a surface 218 configured to define, at least in part, a lower boundary of an operating area 230 in which a composite laminate may be laid up. The operating area 230 is intended to be part of or contained within, at least in part, a negative pressure environment induced between the mold 214 and the cover. The negative pressure may be induced, and a vacuum drawn, by activating a negative pressure source in fluid communication, via a fluid line, with the operating area 230. Such is commonly known in the art.

The first member, namely the mold 214, and particularly the surface 218 of the mold 214, is configured to interface with a sealing surface 244 of a cover, which is shown as existing in the form of a reusable vacuum bag 240, and which reusable vacuum bag 240 is formed in accordance with one or more practices. In one aspect, the reusable vacuum bag 240 is formed after the manner described in any one of U.S. patent application Ser. Nos. 11/418,850, filed May 5, 2006, and entitled, “Vacuum Bagging Methods and Systems” [Attorney Docket No. 02095-22672]; Ser. No. ______, filed ______, and entitled, “Infusion Process for Manufacture of Industrial Composites” [Attorney Docket No. 02095-22690]; Ser. No. ______, filed ______, and entitled, “Caul/Release Layer Combination for Composite Part Manufacture” [Attorney Docket No. 02095-22688]; and Ser. No. ______, filed ______, and entitled, “Rapid Cure, Reusable Vacuum Bag” [Attorney Docket No. 02095-32696], each of which are incorporated by reference in their entirety herein.

The reusable vacuum bag 240 comprises an upper surface that faces away from the mold 214 and a sealing surface 244 designed to be adjacent the surface 218 of the mold 214. The vacuum bag 240 is intended to be flexible or bendable so as to be able to conform to the surface 218 of the mold 214 and any composite lay-up laid over the mold 214, as well as to apply a positive pressure to the composite lay-up, once the vacuum is drawn and the air between the vacuum bag 240 and the mold 214 is displaced. Essentially, the reusable vacuum bag 240 functions to provide a flexible overlay and an upper barrier to enable the fabrication of a composite part using an open mold, and to enclose or envelop the operating area 230 in which a composite lay-up is positioned. The use and function of a vacuum bag, and its associated vacuum bagging process, is well known in the art and not described in detail herein.

The operating area 230 comprises a part of the vacuum sealing or bagging system that is constrained by a resilient sealing component 270, and defines, at least in part, the negative pressure area or vacuum enclosure in which a negative pressure will be induced. The sealing component 270 may be used to define the negative pressure area or vacuum enclosure as the sealing component 270 is intended to seal the vacuum bag 240 to the mold 214. In cooperation with the vacuum bag 240 and the mold 214, the sealing component 270 functions as the peripheral barrier to complete the vacuum enclosure.

In the embodiment shown, the sealing component 270 comprises an elongate, flexible member located or positioned on the sealing surface 244 of the vacuum bag 240. The sealing component 270 may be positioned anywhere along the surface 244, but is preferably positioned in a manner so as to extend around the outer periphery (e.g., along the length and width of the sealing surface 244) near the edges of the sealing surface 244 of the vacuum bag 240. In addition, the sealing component 270 is shown as comprising a continuous configuration designed to seal along its entire length no matter how it is laid out and positioned on the sealing surface 244 of the cover 240. Other sealing components are contemplated herein. In one aspect, the sealing component 270 may be coupled to or integrally formed with the reusable mechanical fastener 290. In another aspect, the sealing component 270 may comprise an independent and separate member from the reusable mechanical fastener 290. In any event, the sealing component 270 is designed and configured to operate with the reusable mechanical fastener 290 as intended herein. The advantage of having a sealing component that is coupled to or integrally formed with the reusable mechanical fastener is that the two can be manipulated together. For example, in disposing one of the fastening or receiving components of the mechanical fastener about the surface of the mold or vacuum bag, manipulation of the whole will effectively position both the sealing and fastening or receiving components, whichever is associated with the sealing component. On the other hand, providing a sealing component that is separate and independent of either of the components of the reusable mechanical fastener allows the sealing component and the fastening or receiving components to be manipulated independent of one another. This may be advantageous for one or more reasons, such as if it is desirable to adjust the vacuum bag with respect to the mold without disrupting the sealing component.

The composite lay-up, shown as including a release layer 202, a preform 204, and a breather or breather/bleeder material 206, is positioned or disposed within the operating area 230, with the reusable vacuum bag 240 overlaid thereon and secured in place, namely to the mold 214, using a reusable mechanical fastener 290. It is noted that the lay-up shown here is not intended to be limiting in any way. In one exemplary embodiment, such as that shown in FIG. 3, the reusable mechanical fastener 290 comprises a receiving component 294 and a fastening component 298 that are configured and operable to mechanically couple together to secure the reusable vacuum bag 240 to the mold 214, and to seal the operating area 230 to permit drawing of a negative pressure therein.

In the embodiment shown, the receiving component 294 of the reusable mechanical fastener 290 is disposed about and supported on the surface 218 of the mold 214, and is configured to receive and mechanically couple the fastening component 298 of the reusable mechanical fastener 290, which fastening component 298 is disposed about and supported on the sealing surface 244 of the vacuum bag 240. In this relationship, the vacuum bag 240 may be secured to the mold 214 by aligning the fastening component 298 with the receiving component 294, and causing the fastening component 298 to come in contact with or engage the receiving component 294, in accordance with the type of fastener being employed. This does not necessarily mean that the fastening component 298 is actually received within the receiving component 294, but such may be the case depending upon the type of reusable mechanical fastener being employed.

The receiving component 294 may be secured or supported about the surface 218 of the mold 214 using any known means in the art, such as an adhesive, screws, bolts, rivets, etc. How the receiving component 294 is securely supported on the mold 214 may depend upon any number of things, such as the type of mechanical fastener being used, the makeup and/or configuration of the mold 214, how much force the mechanical fastener will be subjected to, the direction of such forces, and others. For example, the receiving component may comprise a continuous strand of a loop component of a hook and loop-type fastener that is the counterpart to a hook component. As such, the receiving component or the loop component may be secured to the surface 218 of the mold 214 using an adhesive or bonding agent of some sort. The adhesive or bonding agent should be sufficiently strong for many reasons, such as to resist the tendency of the loop component to lift from the surface of the mold during fabrication of the composite article, which would therefore permit the vacuum bag to also lift, thus potentially breaching the seal, to resist movement of the vacuum bag under negative pressure, which might also potentially breach the seal, as well as to withstand repeated coupling and detaching of the loop component from the hook component supported on the vacuum bag.

Likewise, attachment of the fastening component 298 to the vacuum bag 240 may also be done using means known in the art. These should also be sufficient to adequately secure the fastening component 298 to the vacuum bag 240 for the reasons outlined above with respect to the receiving component 294 as secured to the mold 214.

By aligning and operably relating the fastening component 298 with the receiving component 294, these two are caused to couple together, and to therefore secure the vacuum bag 240 to the mold 214 as intended. Although not required, the reusable mechanical fastener 290 is configured such that the fastening component 298 mechanically couples to the receiving component 294, and therefore securing the cover or vacuum bag 240 to the first member or mold 214 with sufficient force so as to compress the sealing component 270 situated therebetween, as well as to seal the operating area 230 to permit the drawing of a negative pressure therein. To effectuate this, the sealing component 270 may be placed in close proximity to the reusable mechanical fastener 290, such that coupling of the components of the mechanical fastener 290, resultantly causes the sealing component 270 to deform to some degree. This effectively creates a seal that allows the negative pressure source to initially displace or draw air and gasses from between the vacuum bag and the mold, and to form a negative pressure environment. Total or entire deformation of the sealing component 270 may or may not be achieved with the coupling of the mechanical fastener 290. Indeed, further deformation of the sealing component 270 may be desired upon the drawing of a vacuum, and the system configured to permit this. In any event, it is most likely desirable to achieve degree of initial sealing between the vacuum bag and the mold, even if such an initial seal is weak or incomplete. The seal should be sufficient to permit drawing of a vacuum and the creation of a negative pressure environment.

Unlike prior related sealing means, the mechanical fastener 290 is advantageously configured to be reusable in that the fastening component 298 may be repeatedly coupled and detached from the receiving component 294 as many times as necessary or desired to secure and release the cover or vacuum bag from the first member or mold. Thus, unlike prior related systems that utilize a sealant tape to adhere the vacuum bag to the mold, the present invention provides a reusable mechanical fastener that eliminates many of the problems associated with sealant tapes, particularly as applied to a reusable vacuum bag. Different types of reusable mechanical fasteners are described herein, and discussed in more detail below.

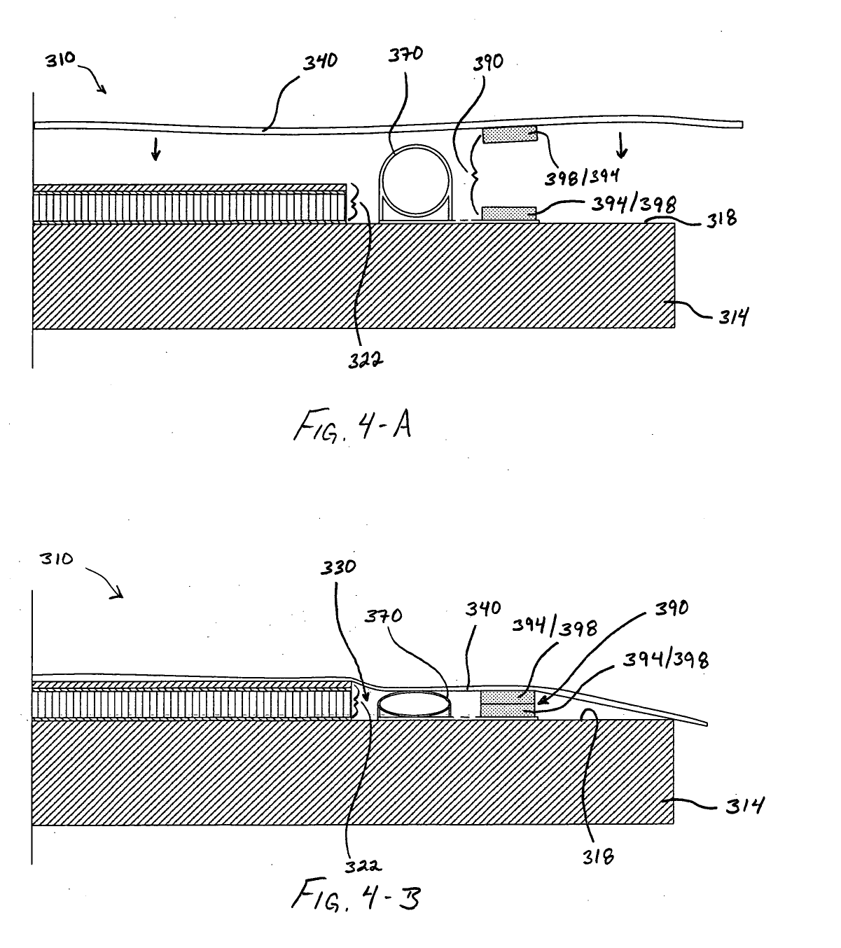

With reference to FIGS. 4-A and 4-B, illustrated is a vacuum sealing system in accordance with another exemplary embodiment, wherein either the receiving component or the fastening component of the reusable mechanical fastener, and the sealing component, are each supported about the first member or mold. The vacuum sealing system 310, shown as a vacuum bagging system for the manufacture of composite parts, comprises a first member in the form of a mold 314 having a surface 318 upon which a composite lay-up 322 is situated. Covering or overlaid upon the mold 314 is a cover in the form of a reusable vacuum bag 340. The reusable vacuum bag 340 and the mold 314 may comprise various types known in the art, such as those described above.

The vacuum sealing system 310 further comprises a reusable mechanical fastener 390 operable with a sealing component 370 to secure and seal the vacuum bag 340 to the mold 314 over the composite lay-up 322. The reusable mechanical fastener 390 comprises a receiving component 394 and a fastening component 398. As shown in the figure, either one of these may be disposed about the mold 314 or the vacuum bag 340. Stated differently, whichever component is disposed about the mold 314, the counterpart component will be disposed about the vacuum bag 340. For example, it is contemplated that either the mold 314 or the vacuum bag 340 may have the receiving component 394 of the reusable mechanical fastener 390 disposed thereon. Likewise, it is contemplated that either the mold 314 or the vacuum bag 340 may have the fastening component 398 of the reusable mechanical fastener 390 disposed thereon.

The reusable mechanical fastener 390 is configured to couple together to secure the vacuum bag 340 to the mold 314. In addition, the reusable mechanical fastener 390 is operable with a resilient sealing component 370 configured to deform to some degree in order to create a seal between the vacuum bag 340 and the mold 314 (see FIG. 4-B). The resilient sealing component 370 may further deform in response to a vacuum being drawn. In essence, the resilient seal 370 is designed and configured to deform to some degree to create a proper seal between opposing surfaces of the mold 314 and the vacuum bag 340. Interior to this seal is the operating area 330 in which the composite lay-up 322 is located.

In the embodiment shown in FIGS. 4-A and 4-B, the resilient seal 370 is adjacent the particular component (either receiving component 394 or fastening component 398) of the reusable mechanical fastener 390 disposed about the surface 318 of the mold 314. As such, the resilient seal 370 is independent of the vacuum bag 340 and the particular component (again either receiving component 394 or fastening component 398 that is not disposed about the mold 314) of the reusable mechanical fastener 390 disposed thereon.

FIGS. 4-A and 4-B further illustrate that the resilient seal 370 may be coupled to or integrally formed with the receiving or fastening components 394 or 398, respectively, of the reusable mechanical fastener 390. Alternatively, the resilient component 370 may be separate and independent from either of these. This concept, as discussed above, is illustrated by the phantom lines connecting the resilient seal 370 to the receiving or fastening components 394 or 398, whichever is used.

FIG. 5 illustrates a vacuum sealing system in accordance with still another exemplary embodiment, wherein either the receiving component or the fastening component of the mechanical fastener, and the sealing component are each supported about a sealing surface of the cover or vacuum bag. This embodiment is similar to the one illustrated in FIG. 4-A, only the sealing component 370 is located on the vacuum bag 440 rather than the mold 414. The vacuum sealing system 410, shown as a vacuum bagging system for the manufacture of composite parts, comprises a first member in the form of a mold 414 having a surface 418 upon which a composite lay-up 422 is situated. Covering or overlaid upon the mold 414 is a cover in the form of a reusable vacuum bag 440. The reusable vacuum bag 440 and the mold 414 may comprise various types known in the art, such as those described above. The vacuum sealing system 410 further comprises a reusable mechanical fastener 490 operable with a sealing component 470 to secure and seal the vacuum bag 440 to the mold 414 over the composite lay-up 422. The reusable mechanical fastener 490 comprises a receiving component 494 and a fastening component 498. Operable with either of these, as disposed about the vacuum bag 340, is the resilient sealing component 470. Each of these function in a similar manner as described herein.

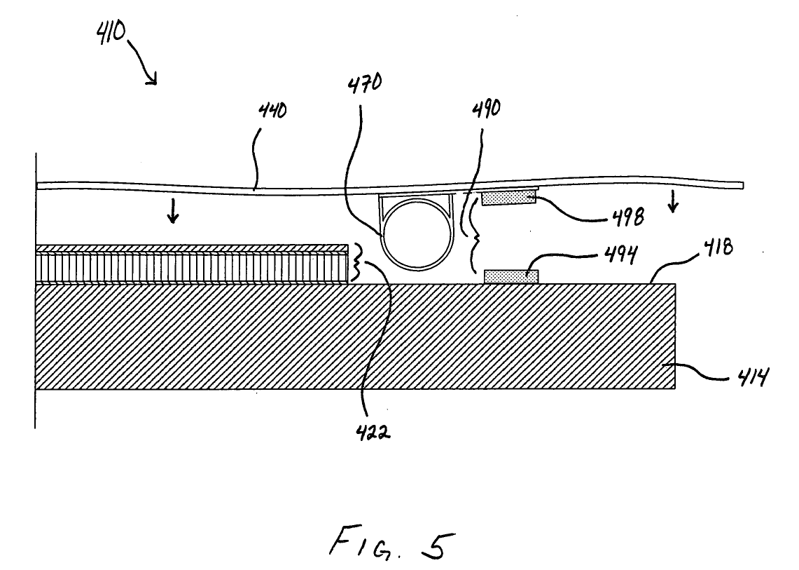

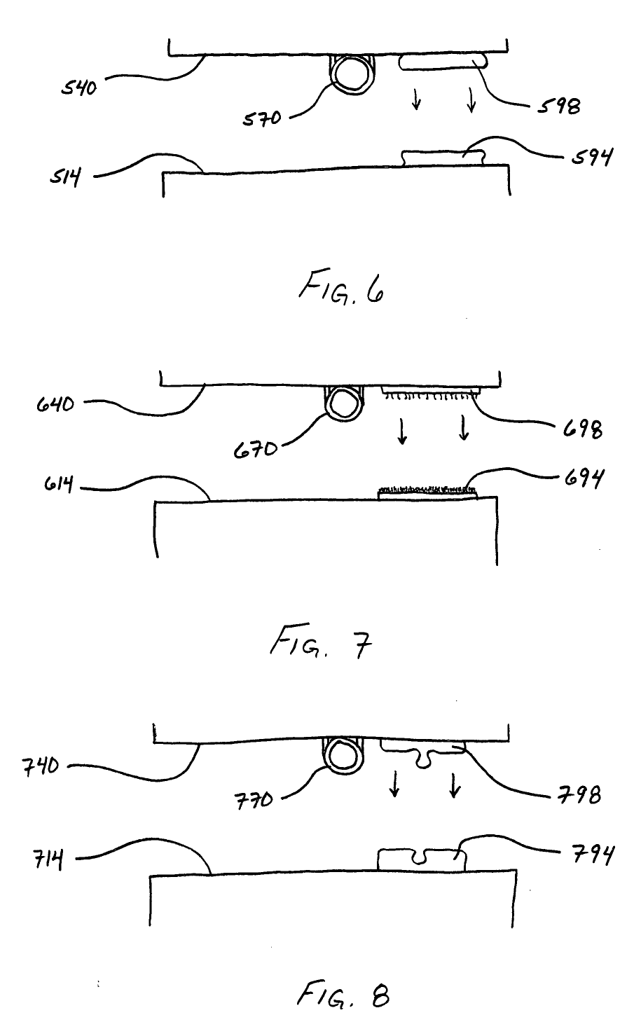

FIGS. 6-8 illustrate various exemplary types of reusable mechanical fasteners. With specific reference to FIG. 6, illustrated is a reusable mechanical fastener in the form of a snap or snap-type fastener 590, wherein the snap 590 comprises a fastening component 598 configured to engage and be received within a receiving component 594 as commonly know in the art. The vacuum sealing system in which the snap-type fastener is used may comprise a plurality of snaps sufficient to secure a cover 540 to a first member 514. The snap 590 is configured to operate or function with a resilient sealing component 570 to seal the cover 540 to the first member 514 as discussed above.

FIG. 7 illustrates another type of reusable mechanical fastener in the form of a hook and loop-type fastener 690, wherein the fastener 690 comprises a fastening component 698 configured to engage a receiving component 694, as commonly known in the art. Unlike the snap-type fastener of FIG. 6, the hook and loop-type fastener may comprise a continuous, elongate configuration extending around the perimeter, or any other portion, of the cover 640 or first member 614. As such, the fastener 690 and the sealing component 670 may be configured to be flexible—to go around corners, conform to various configurations, and to define any desirable vacuum enclosure or negative pressure area. The hook and loop-type fastener 690 is configured to operate or function with a resilient sealing component 670 to seal the cover 640 to the first member 614 as discussed above, which resilient sealing component 670 may be located and supported on either one of the cover 640 or the first member 614.

FIG. 8 illustrates another type of reusable mechanical fastener in the form of a tongue and groove-type fastener 790, wherein the fastener 790 comprises a fastening component 798 configured to engage a receiving component 794, as commonly known in the art. The tongue and groove-type fastener 790 may comprise a continuous, elongate configuration extending around the perimeter, or any other portion, of the cover 740 or first member 714. As such, the fastener 790 and the sealing component 770 may be configured to be flexible. In another aspect, the fastener 790 may be rigid or semi-rigid, with a plurality of segments used to secure the cover 740 to the first member 714. The fastener 790 is configured to operate or function with a resilient sealing component 770 to seal the cover 740 to the first member 714 as discussed above, which resilient sealing component 770 may be located and supported on either one of the cover 740 or the first member 714.

Other types of reusable mechanical fasteners are contemplated by the present invention although not specifically described herein or shown in the drawings. For example, it is contemplated that one or more zippers or buttons may be used. In addition, although not necessarily providing a mechanical coupling, various magnetic-type fasteners may be used. As such, magnets are intended to be included within the meaning of mechanical fasteners, as used herein. In addition, any one of the types of reusable mechanical fasteners may be used in combination with any other type within the same vacuum sealing system.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A vacuum sealing system comprising:
a first member having a surface defining, at least in part, an operating area;
a flexible cover, having a sealing surface, configured to envelop said operating area of said first member;
means for applying negative pressure to said operating area;
a sealing component located between said surface of said first member and said sealing surface of said cover; and
a reusable mechanical fastener operable to mechanically couple said cover to said first member with sufficient force so as to compress said sealing component, and to seal said operating area to permit drawing of a negative pressure.

2. The vacuum sealing system of claim 1, wherein said sealing component is restrained, at least in part, by said reusable mechanical fastener.

3. The vacuum sealing system of claim 1, wherein said sealing component is located about a perimeter of said operating area.

4. The vacuum sealing system of claim 1, wherein said sealing component is supported about said first member.

5. The vacuum sealing system of claim 1, wherein said sealing component is supported about said cover.

6. The vacuum sealing system of claim 1, wherein said mechanical fastener comprises:
a receiving component; and
a fastening component configured to engage said receiving component.

7. The vacuum sealing system of claim 6, wherein said receiving component is supported about one of said first member and said cover, wherein said fastening component is supported about the other of said first member and said cover.

8. The vacuum sealing system of claim 1, wherein said cover comprises a reusable vacuum bag configured for use in the manufacture of composite parts.

9. The vacuum sealing system of claim 8, wherein said first member comprises an open mold operable with said vacuum bag, and configured for use in the manufacture of composite parts.

10. The vacuum seal system of claim 1, wherein said resilient sealing component is independent of said reusable mechanical fastener.

11. The vacuum seal system of claim 1, wherein said reusable mechanical fastener is of a type so as to comprises a continuous configuration that continually couples along a length thereof.

12. The vacuum seal system of claim 1, wherein said reusable mechanical fastener is selected from the group consisting of a hook and loop-type fastener, a snap-type fastener, a zipper-type fastener, a button-type fastener, a tongue and groove-type fastener, a magnetic-type fastener, and any combination of these.

13. The vacuum seal system of claim 1, wherein said sealing component comprises a continuous configuration that continually seals along a length thereof.

14. The vacuum seal system of claim 1, wherein said sealing component comprises a material makeup selected from the group consisting of silicone, vinyl, EPDM, latex, thermoplastic elastomer, and elastomeric gel.

15. The vacuum seal system of claim 1, wherein said sealing component comprises a silicone makeup.

16. The vacuum seal system of claim 1, wherein said sealing component comprises a hollow, tube-like configuration.

17. A vacuum sealing system comprising:
a first member having a surface defining, at least in part, an operating area;
a flexible, reusable cover having a sealing surface configured to interface with said surface of said first member;
a reusable mechanical fastener operable with each of said cover and said first member, said reusable mechanical fastener being configured to temporarily couple together to secure said cover to said first member; and
a resilient sealing component positioned on a surface of one of said cover and said first member, said sealing component temporarily sealing said cover to said first member upon coupling of said mechanical fastener to enable an airtight seal of said operating area, and to permit formation of a negative pressure environment between said cover and said first member, and within said operating area.

18. The vacuum sealing system of claim 17, wherein said first member comprises a mold operable within a vacuum bagging or other composite manufacturing process.

19. The vacuum sealing system of claim 17, wherein said cover comprises a reusable vacuum bag operable within a vacuum bagging or other composite manufacturing process.

20. The vacuum sealing system of claim 17, wherein said resilient sealing component is independent of said reusable mechanical fastener.

21. The vacuum sealing system of claim 17, wherein said reusable mechanical fastener comprises a continuous configuration that continually couples along a length thereof.

22. The vacuum sealing system of claim 17, wherein said reusable mechanical fastener is selected from the group consisting of a hook and loop-type fastener, a snap-type fastener, a zipper-type fastener, a button-type fastener, a tongue and groove-type fastener, a magnetic-type fastener, and any combination of these.

23. The vacuum sealing system of claim 17, wherein said resilient sealing component comprises a continuous configuration that continually seals along a length thereof.

24. The vacuum sealing system of claim 17, wherein said resilient sealing component comprises a material makeup selected from the group consisting of silicone, vinyl, EPDM, latex, thermoplastic elastomer, and elastomeric gel.

25. A vacuum sealing system comprising:
a first member having a surface;
a flexible, reusable cover having a surface configured to interface with said surface of said first member;
a receiving component located on one of said first member and said cover;
a fastening component located on one of said first member and said cover other than that said receiving component is located, said fastening component mechanically releasably engaging said receiving component to temporarily couple together to secure said cover to said first member; and
a resilient sealing component operable with said fastening and receiving components, and positioned on a surface of one of said first member and said cover, said sealing component temporarily sealing said surfaces of said first member and said cover, upon coupling said fastening component to said receiving component, to enable an airtight seal, and to permit formation of a negative pressure environment between said cover and said first member.

26. A reusable vacuum bag comprising:
a flexible material having a sealing surface and an opposing surface;
one of a receiving component and a fastening component of a reusable mechanical fastener operable with and disposed about said sealing surface,
said receiving component functioning to mechanically interact with said fastening component to form a mechanical coupling capable of temporarily securing said vacuum bag to a mold,
said mold comprising the other of said receiving and fastening components not disposed about said vacuum bag,
said reusable mechanical fastener operable with a resilient sealing component positioned between and supported by one of said vacuum bag and said mold to enable an airtight seal, and to permit formation of a negative pressure environment between said vacuum bag and said mold.

27. A method for temporarily sealing a cover to a first member to permit formation of a negative pressure environment between these, said method comprising:
obtaining a first member having a surface;
obtaining a reusable cover having a sealing surface,
said first member and said cover operable with a reusable mechanical fastener and a resilient sealing component to mechanically couple said cover to said first member with sufficient force so as to compress said sealing component, and to permit drawing of a negative pressure,
said reusable mechanical fastener comprising a fastening component and a receiving component; and
coupling said fastening component to said receiving component to secure together said first member and said cover, and to cause said resilient sealing component to seal against said surfaces of said first member and said cover to enable an airtight seal.

28. The method of claim 27, wherein said reusable mechanical fastener functions to secure said resilient seal in place against said sealing surface.

29. A method for temporarily sealing a cover to a first member to permit formation of a negative pressure environment, said method comprising:
obtaining a first member, said first member operable with a cover to facilitate formation of a vacuum enclosure;
positioning a receiving component of a reusable mechanical fastener on a surface of one of said first member and said cover;
positioning a fastening component of said reusable mechanical fastener on a surface of the other of said first member and said cover, said receiving component operable with said fastening component to mechanically couple together, and to secure said cover to said first member; and
positioning a resilient sealing component about said surface of one of said first member and said cover; and
coupling said fastening component to said receiving component to secure said cover to said first members, and to cause said resilient sealing component to deform and seal against said surfaces of said first member and said cover to enable an airtight seal.

30. The method of claim 29, further comprising securing said resilient sealing component against one of said surfaces with at least one of said fastening and receiving components of said reusable mechanical fastener.

31. A method for facilitating formation of a negative pressure environment between a cover and a first member, said method comprising:
providing a reusable mechanical fastener operable to temporarily secure a reusable cover to a first member, said reusable mechanical fastener comprising:
a receiving component configured to be located on a surface of one of said cover and said first member;
a fastening component configured to be located on a surface of the other of said cover and said first member;
facilitating respective application of said receiving and fastening components of said reusable mechanical fastener to either of said cover and said first member;
providing a resilient sealing component operable with said reusable mechanical fastener;
facilitating the positioning of said resilient sealing component between said surfaces of said cover and said first member; and
facilitating the coupling of said receiving and fastening components of said reusable mechanical fastener to secure said cover to said first member, and to cause said resilient sealing component to deform and seal against said surfaces of said cover and said first member to enable an airtight seal, and to permit formation of a negative pressure environment.

32. The method of claim 31, further comprising facilitating the securing of said resilient sealing component against one of said surfaces with at least one of said fastening and receiving components of said reusable mechanical fastener.

33. A method for sealing the surface of a vacuum bag for use in the manufacture of composite parts, said method comprising:
obtaining a reusable vacuum bag having a sealing surface; and
obtaining a mold having a surface defining, at least in part, an operating area,
coupling said vacuum bag to said mold via a reusable mechanical fastener operable with said surfaces of said vacuum bag and said mold, said coupling causing a resilient sealing component located between said surfaces to deform and seal said surfaces together to enable an airtight seal of said operating area, and to enable formation of a negative pressure environment between said vacuum bag and said mold, and within said operating area.
